(19) United States
(12) Patent Application Publication
(10) Pub. No.: US 2023/0235927 A1
(43) Pub. Date: Jul. 27, 2023

(54) Integrated Hybrid Solar Absorption Cooling System

(71) Applicant: D&D Manufacturing, LLC, Titusville, FL (US)

(72) Inventor: Dale E. Polk, JR., Merritt Island, FL (US)

(21) Appl. No.: 17/861,183

(22) Filed: Jul. 9, 2022

Related U.S. Application Data
(60) Provisional application No. 63/302,054, filed on Jan. 22, 2022.

(51) Int. Cl. F25B 27/00; F25B 15/06

(52) U.S. Cl. CPC F25B 27/007; F25B 15/06

(57) ABSTRACT

A system and method for the applying solar heating to an absorption cooling system. Described is either single or double absorption cooling systems in which in a first embodiment the normal generator function of a traditional absorption cooling system is removed from the absorption cooling system and is placed within a solar parabolic trough that acts as a hybrid solar absorber/generator for the absorption cooling system. In a second embodiment the normal condenser function of a traditional absorption cooling system is also removed from the absorption cooling system and placed within the solar parabolic trough, resulting in a hybrid absorber/generator/condenser of the absorption cooling system.

### PRIORITY

This application claims the priority of U.S. provisional application 63/302,054, filed Jan. 22, 2022, which claims the priority of U.S. provisional application 63/220,196, filed Jul. 9, 2021, both by the same inventor as this application.

### FIELD

This disclosure relates to driving an absorption cooling system with a separate solar heating system that that acts as both a solar absorber and the generator and possibly the condenser of one or more absorption cooling systems

### BACKGROUND

Many parts of the world that suffer high climatic temperatures, where refrigeration and air conditioning are therefore important, are too remote to have adequate electricity supply. Solar power has the potential to resolve this problem, but many solar powered refrigeration systems have the problem that they rely on moving mechanical compressors and other parts that consume large amounts of electricity and are liable to failure. Solar thermal collectors demonstrate high efficiency regarding producing high grade heat that is useful directly for heating, cooling via absorption chillers, and storage. Applications include both residential and industrial scale systems.

Regarding absorption cooling systems, the two most used cycles are (1) Lithium Bromide (LiBr)-Water and (2) Ammonia-Water. The LiBr-H₂O appears to be more suitable for small-scale and low-cost solar applications due to lower operating temperature of this cycle and avoids the use of toxic ammonia.

Instead of using a mechanical compressor (usually power-expensive), absorption cooling completes pressurization by dissolving the refrigerant in the absorbent. In case of LiBr-H₂O system, LiBr acts as an absorbent, and H₂O acts as refrigerant. LiBr is a salt, so when the LiBr-H₂O solution boils, water will be driven off, and the LiBr salt will stay. The solubility limit of LiBr in water is quite high, so the solution used in the absorption cycle is very concentrated. It should be noted however, that there are many variants other than LiBr-H20, and Ammonia-Water, and any of them could be used in this proposed system.

In a typical absorption cooling system, there are four main components: a generator, an absorber, a condenser, and an evaporator (where the cooling effect is achieved). The process starts at the generator where heat is input, often from some available waste heat or possibly solar, then the solution in the form of vapor passes to the condenser where rejected heat leaves the system. This goes through an expansion valve into the evaporator where heat is input creating a cooling effect. Once again in the form of vapor the solution travels to the absorber where rejected heat leaves the system. it is subsequently passed to the heat exchangers where it can return to the generator.

As will be shown in this disclosure, the heat input will be solar, but solar used in a way that offers great efficiencies in absorption cooling. Namely the absorption cooling system makes use of an absorber, condenser, and evaporator only. And the solar heating and the generator are combined within a parabolic solar trough. And in a second embodiment the solar heating, generator, and condenser are combined so that the absorption cooling system is made up of only and absorber and evaporator. In addition, the unique design of the combined solar absorber/generator or the combined solar absorber/generator/condenser in the parabolic solar trough allows more extreme concentration of the LiBr (using that as an example system) to the point that it has to moved out of the solar absorber/generator with an augur system because it can be predominately solids.

### BRIEF DESCRIPTION OF THE DRAWINGS

FIG. 1 illustrates an overall view of the solar absorption cooling system of this disclosure.

FIG. 2 illustrates an alternate the same system as FIG. 1 viewed from the top to better illustrate some of the details of the thermal absorber generators that link with the absorption cooling systems of this disclosure.

FIG. 3 is a more detailed view of the internals of a single absorption cooling unit of this disclosure.

FIG. 4 illustrates an alternate embodiment of a single absorption cooling system in which an absorber and evaporator only are outside of the parabolic trough. The solar heating/generator/condenser are all combined within the parabolic solar trough.

FIG. 5 illustrates the alternate embodiment of FIG. 5 in a double absorption configuration. Again the solar heating/generator/condenser are all combined within the parabolic solar trough.

### BRIEF SUMMARY

This disclosure describes a novel hybrid solar absorption cooling system in which in a first embodiment the normal generator component of an absorption cooling system is removed from the absorption cooling system(s) and integrated into the focal point of a parabolic solar trough in such a way that the focal point of the parabolic solar trough is a combined solar absorber and generator of an absorption cooling system. And in a second embodiment both the normal generator and the condenser of a solar absorption cooling system are removed from the absorption cooling system(s) and integrated into the focal point of a parabolic solar trough in such a way that the focal point of the parabolic solar trough is a combined solar absorber, generator, and condenser of the hybrid solar absorption cooling system. The proposed systems can support either a single or double absorption system in which the there is either one absorption cooling system on one side of the parabolic solar trough or one on each side of the parabolic solar trough. But in the first embodiment the hybrid solar absorption cooling systems will not have a generator since the generator has been placed within the parabolic solar trough. And in the second embodiment the hybrid solar absorption cooling systems will not have a generator or condenser since they now are combined into the combined solar absorber, generator, and condenser of the hybrid solar absorption cooling system.

The disclosure also describes a novel method for utilizing a solar driven absorption cooling system, either single or double by providing absorption cooling in which in a first embodiment the normal generator component of an absorption cooling system is removed from the absorption cooling system and integrated into the focal point of a parabolic solar trough in such a way that the focal point of the parabolic solar trough is a combined solar absorber and generator of a hybrid solar absorption cooling system or in a second embodiment both the normal generator component and the normal condenser component are integrated into the focal point of a parabolic solar trough in such a way that the focal point of the parabolic solar trough is a combined solar absorber/generator/condenser of the hybrid solar absorption cooling system.

A further description of a single hybrid solar absorption cooling system in which the normal generator component of an absorption cooling system is removed from the absorption cooling system and integrated into the focal point of a parabolic solar trough in such a way that the focal point of the parabolic solar trough is a combined solar absorber and generator for the absorption cooling system, and the remaining absorption cooling components of the absorptive cooling system of a condenser, evaporator, and absorber are in fluid communication with the combined solar absorber and generator includes at least an internal auger system in the pipe of the combined solar absorber and generator positioned in the combined solar absorber and generator to drive any potential solid LiBr as the water is removed from a LiBr-Water refrigerant; a condenser in fluid communication with the combined solar absorber and generator positioned within the focal point of the parabolic solar trough, which receives and condenses a refrigerant vapor leaving the combined absorber/generator at a first end of the combined absorber/generator, the condenser being cooled by a cooling water loop, cooling the very hot refrigerant vapor to convert it to liquid that is subsequently expanded in an expansion valve to provide additional cooling to the overall system; an evaporator in fluid communication with the condenser via the expansion valve; the evaporator containing a building cooling loop which provides cooling to any structure being cooled; an absorber in fluid communication with the evaporator to receive refrigerant vapor from the evaporator, the refrigerant vapor coming into contact with a highly concentrated LiBr exiting the combined absorber/generator and the combination generates a weak solution for feeding back via a pump into a second end of the combined absorber/generator positioned within the focal point of the parabolic solar trough, to repeat the loop of the refrigerant system; wherein the weak solution is first used to cool the hot concentrated solution coming from the combined solar absorber/generator via a heat exchanger before the weak solution is fed back via the pump into a second end of the combined absorber/generator positioned within the focal point of the parabolic solar trough.

A further description of a double hybrid solar absorption cooling system in which the normal generator component of each absorption cooling system is removed from its absorption cooling system and integrated into the focal point of a parabolic solar trough in such a way that the focal point of the parabolic solar trough contains two combined solar absorber and generator systems installed back-to-back within the parabolic solar trough for the two absorption cooling systems, and the remaining absorption cooling components of the two absorptive cooling systems, each comprising a condenser, evaporator, and absorber are in fluid communication with their combined solar absorber and generators includes at least an internal auger system in the pipe of each of the combined solar absorber and generators positioned in the two combined solar absorber and generators to drive any potential solid LiBr as the water is removed from their LiBr-Water refrigerant systems; a condenser on each side of the two combined solar absorber and generator systems installed back-to-back within the parabolic solar trough in fluid communication with the associated combined solar absorber and generator positioned within the focal point of the parabolic solar trough, which receives and condenses a refrigerant vapor leaving the combined absorber/generator at a first end of the combined absorber/generator, the condenser being cooled by a cooling water loop, cooling the very hot refrigerant vapor to convert it to liquid that is subsequently expanded in an expansion valve to provide additional cooling to the overall system; an evaporator on each side in fluid communication with their associated condensers via an expansion valve and an absorber; each evaporator containing a building cooling loop which provides cooling to any structures being cooled; absorbers in fluid communication with their associated evaporators to receive refrigerant vapor from their evaporator, the refrigerant vapor coming into contact with a highly concentrated LiBr exiting their associated combined absorber/generators and the combination generates a weak solution for feeding back via a pump into a second end of the combined absorber/generator positioned within the focal point of the parabolic solar trough, to repeat the loops of the double refrigerant systems; wherein the weak solutions are first used to cool the hot concentrated solutions coming from the combined solar absorber/generators via heat exchangers before the weak solutions are fed back via their associated pumps into the second ends of the combined absorber/generators positioned within the focal point of the parabolic solar trough.

A further description of a single hybrid solar absorption cooling system in which both the normal generator component of an absorption cooling system and the condenser component is removed from the absorption cooling system and integrated into the focal point of a parabolic solar trough in such a way that the focal point of the parabolic solar trough is a combined solar absorber/generator/condenser all combined within the parabolic solar trough for the absorption cooling system, and the remaining absorption cooling components of the absorptive cooling system of an evaporator and absorber are in fluid communication with the combined solar absorber/generator/condenser includes at least: an internal auger system in the pipe of the combined absorber/generator/condenser positioned in the combined solar absorber/generator/condenser to drive any potential solid LiBr as the water is removed from a LiBr-Water refrigerant; wherein, as the LiBr-Water refrigerant flows through the combined solar absorber/generator/condenser refrigement vapor comes off and the bottom liquid system becomes much more concentrated and the refrigement vapor coming off of the combined solar absorber/generator/condenser is redirected back into a pipe positioned below the liquid level in the combined absorber/generator/condenser, where it is cooled counter currently and condensed back into a liquid and then fed through a pressure multiplying pump before being fed through an expansion valve into the evaporator; an evaporator in fluid communication with the combined solar absorber/generator/condenser via an expansion valve; the evaporator containing a building cooling loop which provides cooling to any structures being cooled; an absorber in fluid communication with the evaporator to receive refrigerant vapor from the evaporator, the refrigerant vapor coming into contact with a highly concentrated LiBr exiting the combined solar absorber/generator/condenser and the combination generating a weak solution for feeding back via a pump into a second end of the combined absorber/generator/condenser positioned within the focal point of the parabolic solar trough, to repeat the loop of the refrigerant system; wherein the weak solution is first used to cool the hot concentrated solution coming from the combined solar absorber/generator/condenser via a heat exchanger before the weak solution is fed back via the pump into a second end of the combined absorber/generator positioned within the focal point of the parabolic solar trough.

A further description of a double hybrid solar absorption cooling system in which both the normal generator component of an absorption cooling system and the condenser component is removed from the absorption cooling system and integrated into the focal point of a parabolic solar trough in such a way that the focal point of the parabolic solar trough is a combined solar absorber/generator/condenser all combined within the parabolic solar trough for the absorption cooling system, and the remaining absorption cooling components of the absorptive cooling system of an evaporator and absorber are in fluid communication with the combined solar absorber/generator/condenser comprising: an internal auger system in the pipe of each of the combined solar absorber/generator/condensers positioned in the two combined solar absorber/generator/condensers to drive any potential solid LiBr as the water is removed from their LiBr-Water refrigerant systems; evaporators on each side in fluid communication with their associated combined solar absorber/generator/condenser via an expansion valve and an absorber; each evaporator containing a building cooling loop which provides cooling to any structures being cooled; an absorber in fluid communication with the evaporator to receive refrigerant vapor from the evaporator, the refrigerant vapor coming into contact with a highly concentrated LiBr exiting the combined absorber/generator and the combination generates a weak solution for feeding back via a pump into a second end of the combined solar absorber/generator/condenser positioned within the focal point of the parabolic solar trough, to repeat the loop of the refrigerant system; wherein the weak solutions are first used to cool the hot concentrated solutions coming from the combined solar absorber/generator/condensers via heat exchangers before the weak solutions are fed back via their associated pumps into the second ends of the combined absorber/generators positioned within the focal point of the parabolic solar trough.

### DETAILED DESCRIPTION

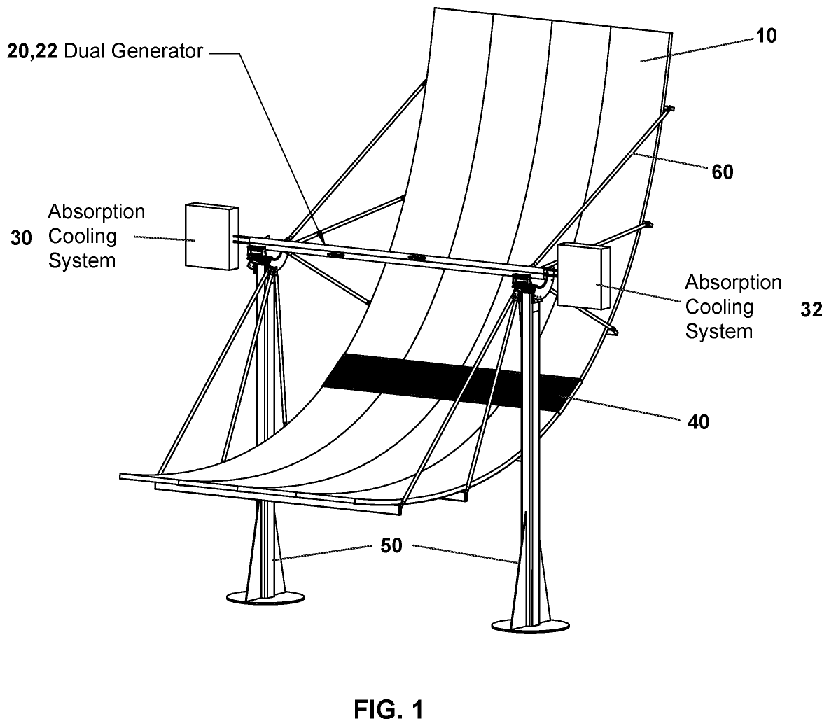

Referring now to FIG. 1 and the first embodiment of the solar absorption system of this disclosure a double absorption system with two units 30 and 32 on each side of a parabolic solar trough 10 is shown. Note that this figure is not to scale as the absorption cooling systems 30 and 32 will be much larger than shown and will be illustrated in later figures. It should also be noted that a single absorption system can be employed with only one unit 32 on one side of the parabolic solar trough and that will also be illustrated in later figures.

Within the parabolic solar trough, a dual set of combined solar adsorption and generator systems 20 and 22, mounted side-by-side provide the generator requirement of traditional absorption cooling systems, thus removing the need for generators in absorption cooling systems 30 and 32. The resulting alternate absorption cooling system will be illustrated in more detail in later figures.

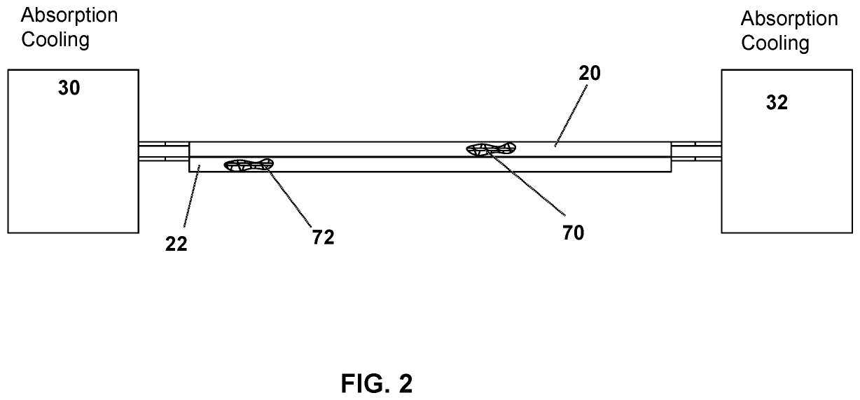

Turning now to FIG. 2, we illustrate more of a top-down view of the combined solar absorber/generators to illustrate that there are two combined solar absorber/generators 20 and 22 aligned back-to-back to work with double absorption cooling systems 30 and 32. In the case of using a single absorption cooling system there would only be one solar absorber/generator within the parabolic solar trough.

Still looking at FIG. 2, each of the two combined solar absorber/generators 20 and 22 have internal auger systems 70 and 72 that are utilized to drive predominately solid LiBr from their combined solar absorber/generators 20 and 22 as the water is removed from the LiBr-Water refrigerant. This important feature leads to significantly improved efficiency as the highly concentrated (or solid) LiBr is then absorbed into the cooler water vapor passing from the evaporator and the LiBr goes back into a weak solution for reuse. Note that these auger systems may not be needed in alternate refrigerant systems (such as ammonia/water), but will be important in popular LiBr-water refrigerant systems.

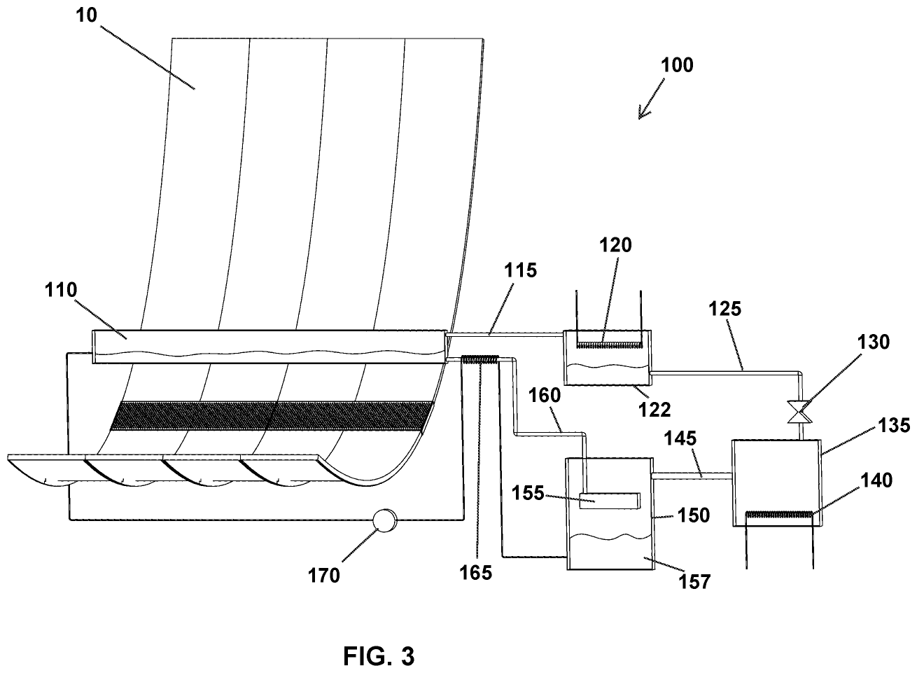

Turning now to FIG. 3, shown generally as numeral 100 is an illustration of the details of a single absorption cooling system of this disclosure. The combined absorber/generator 110 is now a single combined absorber/generator rather than the dual combined absorber/generators 20 and 22 shown in FIGS. 1 and 2.

The major elements of the single absorption cooling system shown here are a condenser 122, which condenses refrigerant vapor 115 leaving the combined absorber/generator 110, an evaporator 135, and an absorber 150. The refrigerant weak solution 157 that is shown in absorber 150 is pumped via pump 170 to the other side of the parabolic solar trough 10 and into the single combined absorber/generator 110 where it is heated by the solar input as it passes from left to right in the figure. As it flows from left to right through the combined absorber/generator 110 refrigerant vapor comes off and the bottom liquid system in 110 becomes much more concentrated. The refrigerant vapor then flows out of combined absorber/generator 110 via pipe 115 from a first end of the combined absorber/generator into condenser 122 where it is cooled and condensed by a cooling water loop 120. The cooling water loop in the condenser provides the cooling of the very hot refrigerant vapor to convert it to liquid that is subsequently expanded in expansion valve 130 to provide additional cooling to the overall system. The water in that cooling water loop 120 could come, for example, from a water tower.

The condensed refrigerant 125 is then fed through and an expansion valve 130 and into evaporator 135, letting down the pressure, which immediately provides a cooling effect. Within evaporator 135 is the building cooling loop 140 which provides cooling to the structure being cooled. Refrigerant vapor from evaporator 135 then flows to absorber 150 via line 145.

In absorber 150 the refrigerant vapor comes into contact with the highly concentrated (possibly semi-solid) LiBr exiting combined absorber/generator 110 via pipe 160 and again generates a weak solution 157 for feeding back into the combined absorber/generator 110. This weak solution 157 is cooler and is used to cool the hot and very concentrated solution coming from combined solar absorber/generator 110 using heat exchanger 165. Component 155 could be a sprayer when the flow on pipe 160 is a highly concentrated LiBr solution coming from the combined solar absorber/generator 110 and other designs could be used when the LiBr is a semi-solid or solid driven by the internal augers (described earlier in FIG. 2) in the combined solar absorber/generator 110.

In a further possible embodiment of this disclosure the absorber/generator conditions can be used to drive off all the water from the weak solution entering the absorber/generator 110 and the internal auger within the absorber/generator then delivers solid LiBr into absorber 150.

Note that the detailed disclosure of the single absorption cooling system applies also to the double absorption system. There is simply a similar system on the other side of the parabolic solar trough (FIGS. 1 and 2) and the combined absorber/generator has two combined absorber/generators 20, 22 installed back-to-back within the parabolic solar trough 10. The two absorption systems 30, 32 though are essentially identical.

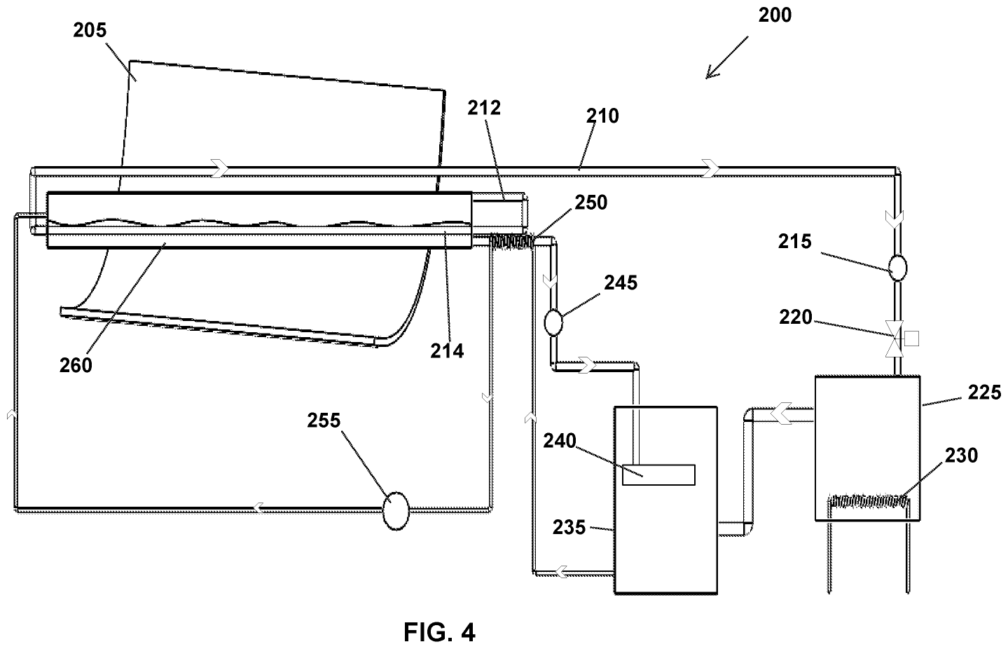

Turning now to FIG. 4 we now describe a further embodiment of a hybrid solar absorption cooling system. In this embodiment the solar absorption cooling system is further simplified by basically moving the condenser function (122 in FIG. 3) into the parabolic solar trough so that the solar trough is now a combined solar heating/generator/condenser all combined within the parabolic solar trough so that the absorption cooling function now is simplified to an evaporator and absorber. This embodiment also enables the elimination of the cooling water loop 120 of FIG. 3.

The major elements of the single absorption cooling system of FIG. 4 are an evaporator 225, and an absorber 235. The refrigerant weak solution exiting at the bottom of absorber 235 is pumped via pump 255, first through a heat exchanger 250 to conserve heat and then to the other side of the parabolic solar trough 205 and into the single combined absorber/generator/condenser 260 where it is heated by the solar input as it passes from left to right in the figure. As it flows from left to right through the combined absorber/generator/condenser 260 refrigement vapor comes off and the bottom liquid system becomes much more concentrated. The refrigerant vapor then flows out of the combined absorber/generator/condenser 260 via pipe 212 and then is redirected back into a pipe 214 positioned below the liquid level in combined absorber/generator/condenser 260, flowing counter currently against the incoming and cooler weak solution coming from weak solution pump 255, and is cooled and condensed back to a liquid. That now liquid refrigerant is fed through pipe 210 through a pressure multiplying pump 215 and is expanded in expansion valve 220 and into evaporator 225, providing an immediate cooling effect to provide cooling to the overall system as it is expanded back into a vapor.

Within evaporator 225 is the building cooling loop 230 which provides cooling to the structure being cooled, and refrigerant vapor from evaporator 225 then flows to absorber 235.

In absorber 235 the refrigerant vapor comes into contact with the highly concentrated (possibly semi-solid) LiBr exiting combined absorber/generator/condenser 260, pumped via absorber feed pump 245 into absorber 235 and after combining with the water vapor exiting evaporator 245 is fed back into the combined absorber/generator/condenser 260 by weak solution pump 255. This weak solution exiting absorber 235 is cooler and is used to cool the very concentrated solution coming from combined solar absorber/generator/condenser 260 using heat exchanger 250. Component 240 in absorber 235 could be a sprayer when the flow from combined absorber/generator/condenser 260 is a highly concentrated LiBr solution coming from the combined solar absorber/generator 260 and or other designs could be used if the LiBr is a semi-solid or solid driven by an internal auger in the combined solar absorber/generator/condenser 260.

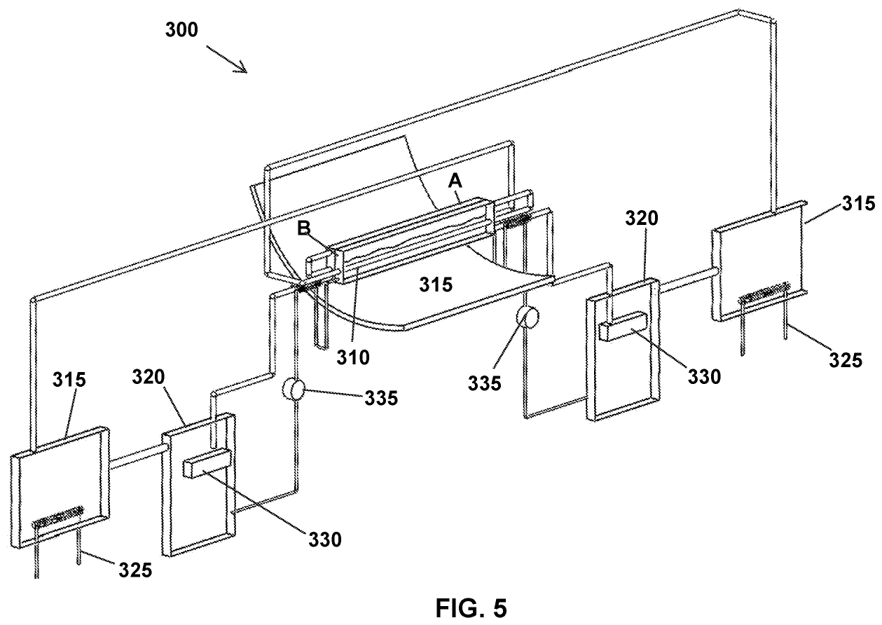

And in FIG. 5 we simply illustrate again the second embodiment of a combined absorber/generator/condenser, but now configured as a double system. The combined absorber/generator/condenser 310 is now shown as two back-to-back systems A and B contained within solar trough 315 that are identical with each connected to an absorption cooling system comprising only an evaporator and absorber subsystem. As illustrated previously in FIG. 4, each side of the combined absorber/generator/condenser has as both an evaporator 315 and an absorber 320, which work in the same way as described previously in the single system described in FIG. 4.

The use of parabolic solar troughs has obvious advantages related to energy savings. It should be noted though that there are applications in which 24-hour power is needed and the concepts exemplified here could use other sources such as gas or electric heaters to heat the elongated tube when solar impingement is not available. The system described would work in the same way in providing efficient removal of refrigerant from absorption cooling solutions.

This disclosure has been described with reference to specific details of particular embodiments. It is not intended that such detailed be regarded as limitations upon the scope of the invention except insofar as and to the extent that they are included in the eventual claims.

1. A single hybrid solar absorption cooling system in which the normal generator component of an absorption cooling system is removed from the absorption cooling system and integrated into the focal point of a parabolic solar trough in such a way that the focal point of the parabolic solar trough is a combined solar absorber and generator for the absorption cooling system, and the remaining absorption cooling components of the absorptive cooling system of a condenser, evaporator, and absorber are in fluid communication with the combined solar absorber and generator comprising:
a. an internal auger system in the pipe of the combined solar absorber and generator positioned in the combined solar absorber and generator to drive any potential solid LiBr as the water is removed from a LiBr-Water refrigerant;
b. a condenser in fluid communication with the combined solar absorber and generator positioned within the focal point of the parabolic solar trough, which receives and condenses a refrigerant vapor leaving the combined absorber/generator at a first end of the combined absorber/generator, the condenser being cooled by a cooling water loop, cooling the very hot refrigerant vapor to convert it to liquid that is subsequently expanded in an expansion valve to provide additional cooling to the overall system;
c. an evaporator in fluid communication with the condenser via the expansion valve; the evaporator containing a building cooling loop which provides cooling to any structure being cooled;
d. an absorber in fluid communication with the evaporator to receive refrigerant vapor from the evaporator, the refrigerant vapor coming into contact with a highly concentrated LiBr exiting the combined absorber/generator and the combination generates a weak solution for feeding back via a pump into a second end of the combined absorber/generator positioned within the focal point of the parabolic solar trough, to repeat the loop of the refrigerant system;
e. wherein the weak solution is first used to cool the hot concentrated solution coming from the combined solar absorber/generator via a heat exchanger before the weak solution is fed back via the pump into a second end of the combined absorber/generator positioned within the focal point of the parabolic solar trough.

2. A double hybrid solar absorption cooling system in which the normal generator component of each absorption cooling system is removed from its absorption cooling system and integrated into the focal point of a parabolic solar trough in such a way that the focal point of the parabolic solar trough contains two combined solar absorber and generator systems installed back-to-back within the parabolic solar trough for the two absorption cooling systems, and the remaining absorption cooling components of the two absorptive cooling systems, each comprising a condenser, evaporator, and absorber are in fluid communication with their combined solar absorber and generators comprising:
a. an internal auger system in the pipe of each of the combined solar absorber and generators positioned in the two combined solar absorber and generators to drive any potential solid LiBr as the water is removed from their LiBr-Water refrigerant systems;
b. a condenser on each side of the two combined solar absorber and generator systems installed back-to-back within the parabolic solar trough in fluid communication with the associated combined solar absorber and generator positioned within the focal point of the parabolic solar trough, which receives and condenses a refrigerant vapor leaving the combined absorber/generator at a first end of the combined absorber/generator, the condenser being cooled by a cooling water loop, cooling the very hot refrigerant vapor to convert it to liquid that is subsequently expanded in an expansion valve to provide additional cooling to the overall system;
c. an evaporator on each side in fluid communication with their associated condensers via an expansion valve and an absorber; each evaporator containing a building cooling loop which provides cooling to any structures being cooled;
d. absorbers in fluid communication with their associated evaporators to receive refrigerant vapor from their evaporator, the refrigerant vapor coming into contact with a highly concentrated LiBr exiting their associated combined absorber/generators and the combination generates a weak solution for feeding back via a pump into a second end of the combined absorber/generator positioned within the focal point of the parabolic solar trough, to repeat the loops of the double refrigerant systems;
e. wherein the weak solutions are first used to cool the hot concentrated solutions coming from the combined solar absorber/generators via heat exchangers before the weak solutions are fed back via their associated pumps into the second ends of the combined absorber/generators positioned within the focal point of the parabolic solar trough.

3. A single hybrid solar absorption cooling system in which both the normal generator component of an absorption cooling system and the condenser component is removed from the absorption cooling system and integrated into the focal point of a parabolic solar trough in such a way that the focal point of the parabolic solar trough is a combined solar absorber/generator/condenser all combined within the parabolic solar trough for the absorption cooling system, and the remaining absorption cooling components of the absorptive cooling system of an evaporator and absorber are in fluid communication with the combined solar absorber/generator/condenser comprising:
a. an internal auger system in the pipe of the combined absorber/generator/condenser positioned in the combined solar absorber/generator/condenser to drive any potential solid LiBr as the water is removed from a LiBr-Water refrigerant;
b. wherein, as the LiBr-Water refrigerant flows through the combined solar absorber/generator/condenser refrigement vapor comes off and the bottom liquid system becomes much more concentrated and the refrigement vapor coming off of the combined solar absorber/generator/condenser is redirected back into a pipe positioned below the liquid level in the combined absorber/generator/condenser, where it is cooled counter currently and condensed back into a liquid and then fed through a pressure multiplying pump before being fed through an expansion valve into the evaporator;
c. an evaporator in fluid communication with the combined solar absorber/generator/condenser via an expansion valve; the evaporator containing a building cooling loop which provides cooling to any structures being cooled;
d. an absorber in fluid communication with the evaporator to receive refrigerant vapor from the evaporator, the refrigerant vapor coming into contact with a highly concentrated LiBr exiting the combined solar absorber/generator/condenser and the combination generating a weak solution for feeding back via a pump into a second end of the combined absorber/generator/condenser positioned within the focal point of the parabolic solar trough, to repeat the loop of the refrigerant system;
e. wherein the weak solution is first used to cool the hot concentrated solution coming from the combined solar absorber/generator/condenser via a heat exchanger before the weak solution is fed back via the pump into a second end of the combined absorber/generator positioned within the focal point of the parabolic solar trough.

4. A double hybrid solar absorption cooling system in which both the normal generator component of an absorption cooling system and the condenser component is removed from the absorption cooling system and integrated into the focal point of a parabolic solar trough in such a way that the focal point of the parabolic solar trough is a combined solar absorber/generator/condenser all combined within the parabolic solar trough for the absorption cooling system, and the remaining absorption cooling components of the absorptive cooling system of an evaporator and absorber are in fluid communication with the combined solar absorber/generator/condenser comprising:
a. an internal auger system in the pipe of each of the combined solar absorber/generator/condensers positioned in the two combined solar absorber/generator/condensers to drive any potential solid LiBr as the water is removed from their LiBr-Water refrigerant systems;
b. evaporators on each side in fluid communication with their associated combined solar absorber/generator/condenser via an expansion valve and an absorber; each evaporator containing a building cooling loop which provides cooling to any structures being cooled;
c. absorbers on each side in fluid communication with the evaporators to receive refrigerant vapor from the evaporators, the refrigerant vapor coming into contact with a highly concentrated LiBr exiting the combined absorber/generators and the combination generates a weak solution for feeding back via a pump into a second end of the combined solar absorber/generator/condensers positioned within the focal point of the parabolic solar trough, to repeat the loop of the refrigerant system;
d. wherein the weak solutions are first used to cool the hot concentrated solutions coming from the combined solar absorber/generator/condensers via heat exchangers before the weak solutions are fed back via their associated pumps into the second ends of the combined absorber/generators positioned within the focal point of the parabolic solar trough.
